(19) United States
(12) Patent Application Publication
(10) Pub. No.: US 2019/0063147 A1
(43) Pub. Date: Feb. 28, 2019

(54) POSITIONING STRUCTURE FOR CORDLESS WINDOW BLIND

(71) Applicant: SUNG-PO CHENG, Changhua (TW)

(72) Inventor: SUNG-PO CHENG, Changhua (TW)

(21) Appl. No.: 15/691,787

(22) Filed: Aug. 31, 2017

(51) Int. Cl. E06B 9/322; B65H 75/48

(52) U.S. Cl. CPC E06B 9/322; B65H 75/486

(57) ABSTRACT

A positioning structure for cordless window blind comprise a lower case, a driving gear wheel, a driven gear wheel, a coil spring, two pull-cord gear wheels, two one-way resistance wheels, and an upper case. The two one-way resistance wheels are arranged on the lower case and respectively adjacent to the two pull-cord gear wheels. Each one-way resistance wheel has a resistance block and an elastic member. The resistance block has two polygonal holes. One end of the elastic member is fastened to the resistance block. The two pull cords are respectively fastened to the two pull-cord gear wheels and respectively winded around the two one-way resistance wheels at least one loop. The upper case has two polygonal posts which are respectively inserted into the two polygonal holes.

### FIELD OF THE INVENTION

The present invention relates to a cordless window blind, and more particularly to a positioning structure for cordless window blind.

### BACKGROUND OF THE INVENTION

The conventional positioning structure or locating structure for cordless window blind may be shown as U.S. Pat. No. 9,366,077 (hereafter '077) and U.S. Pat. No. 9,482,049 (hereafter '049).

'077 disclosed a window body positioning mechanism of a non pull cord window blind which includes two first transmission wheels, two transmission cords respectively connected with one ends thereof to the first transmission wheels, two second transmission wheels meshed together and respectively meshed with the first transmission wheels, a coil spring connecting the two second transmission wheels and selectively wound round one second transmission wheel, and two resistance units each including a one-way pawl and a resistance wheel wound by one respective transmission cord and meshed with the one-way pawl. Thus, when extending out or receiving the blind body, the friction resistance between the resistance wheels and the transmission cords and the engagement relationship between the resistance wheels and the respective one-way pawls help achieve excellent blind body positioning effects.

'049 disclosed a curtain body locating mechanism of a curtain with no cord which mainly utilizes two separation and reunion units to control the locating effect when a curtain body is being spread or folded. The separation and reunion unit comprises an axle, two braking blocks, a separation and reunion wheel and two planetary gears. The two braking blocks are spaced apart and connected to the periphery of the axle so that a rolling groove is formed between the two braking blocks. The separation and reunion wheel is nested onto the axle and has an inner ring gear surrounding the two braking blocks. Each of the planetary gears is disposed within one of the rolling grooves and engaged with the inner ring gear of the separation and reunion wheel.

In '077, the one-way pawl and resistance shrapnel are arranged outside of the resistance wheel so that the total volume becomes larger, the space in the headrail becomes smaller, and the friction is hard to be stably controlled. In '049, it disclosed the planetary gear structure which is arranged in the resistance wheel. However, they are hard to be assembled in the resistance wheel and the friction is hard to be stably controlled.

In view of the foregoing circumstances, the inventor has invested a lot of time to study the relevant knowledge, compare the pros and cons, research and develop related products. After quite many experiments and tests, the “positioning structure” of this invention is eventually launched to improve the foregoing shortcomings, to meet the public use.

### SUMMARY OF THE INVENTION

An objective of this invention is providing a positioning structure for cordless window blind. It may provide relatively stable friction to prevent the window blind from unwantedly falling from a highest point and unwanted rebounding from a lowest point.

To achieve above objectives, a positioning structure for cordless window blind comprises a lower case; a driving gear wheel, pivotably arranged on the lower case; a driven gear wheel, pivotably arranged on the lower case and engaged with the driving gear wheel; a coil spring, winding around the driven gear wheel, and two ends of the coil spring are respectively fastened at the driving gear wheel and the driven gear wheel; two pull-cord gear wheels, pivotably arranged on the lower case and respectively engaged with the driving gear wheel and the driven wheel; two one-way resistance wheels, pivotably arranged on the lower case, the two one-way resistance wheels are respectively arranged adjacent to the two pull-cord gear wheels, each one-way resistance wheel has a resistance block and an elastic member received therein, the resistance block has a polygonal hole, one end of the elastic member is fastened to the resistance block, two pull cords are respectively fastened to the two pull-cord gear wheels, and each pull cord is winded around an outer peripheral of corresponding one-way resistance wheel at least one loop; and an upper case, detachably covered the lower case, each pull-cord gear wheel, the driving gear wheel, the driven gear wheel, the coil spring, and each one-way resistance wheel are arranged between the lower case and the upper case, the upper case has two polygonal posts, each polygonal post is arranged corresponding to each polygonal hole, and each polygonal post is inserted into the corresponding polygonal hole.

In some embodiment, the resistance block is a C-shaped resistance block, the elastic member is a compression spring, the compression spring is arranged at an open end of the C-shaped resistance block.

In some embodiment, the resistance block is a ring-shaped resistance block, a break is formed at a peripheral of the ring-shaped resistance block, the elastic member is a ring-shaped shrapnel, one end of the ring-shaped shrapnel is inserted and fastened in the break of the ring-shaped resistance block and the other end thereof is extended counterclockwise and contacted with an inner peripheral of the one-way resistance wheel.

In some embodiment, the resistance block is a ring-shaped resistance block, three breaks are angularly spaced apart from one another and formed at a peripheral of the ring-shaped resistance block, the elastic member is composed of three ring-shaped shrapnels, one end of each ring-shaped shrapnel is inserted and fastened in each break of the ring-shaped resistance block and the other end thereof is extended counterclockwise and contacted with an inner peripheral of the one-way resistance wheel.

In some embodiment, the driven gear wheel is pivotably assembled to a shaft, and the coil spring winds around the shaft.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a partial exploded view of a cordless window blind of the present invention.

FIG. 2 is a plan view of the cordless window blind of the present invention.

FIG. 3 is an exploded view of a first embodiment of a one-way resistance wheel of a positioning structure for the cordless window blind.

FIG. 4 is an exploded view of the first embodiment of the one-way resistance wheel while shows only an upper case, a lower case, and two one-way resistance wheels.

FIG. 5 is a perspective view of the first embodiment of the one-way resistance wheel.

FIG. 6 is a plan view of the positioning structure which includes the first embodiment of the one-way resistance wheels while being in a tight status.

FIG. 7 is a plan view of the positioning structure which includes the first embodiment of the one-way resistance wheels while being in a release status.

FIG. 8 is a plan view of the left side in FIG. 6.

FIG. 9 is a plan view of the left side in FIG. 7.

FIG. 10 is an exploded view of a second embodiment of the one-way resistance wheel of a positioning structure for the cordless window blind.

FIG. 11 is a view of the positioning structure which includes the second embodiment of the one-way resistance wheels while being in a release status.

FIG. 12 is a plan view of the left side in FIG. 11.

FIG. 13 is a view of a third embodiment of the one-way resistance wheel of a positioning structure for the cordless window blind.

FIG. 14 is a view of the positioning structure which includes the third embodiment of the one-way resistance wheels while being in a release status.

FIG. 15 is a plan view of the left side in FIG. 14.

### DESCRIPTION OF THE PREFERRED EMBODIMENT

Referring now to the drawings where like characteristics and features among the various figures are denoted by like reference characters.

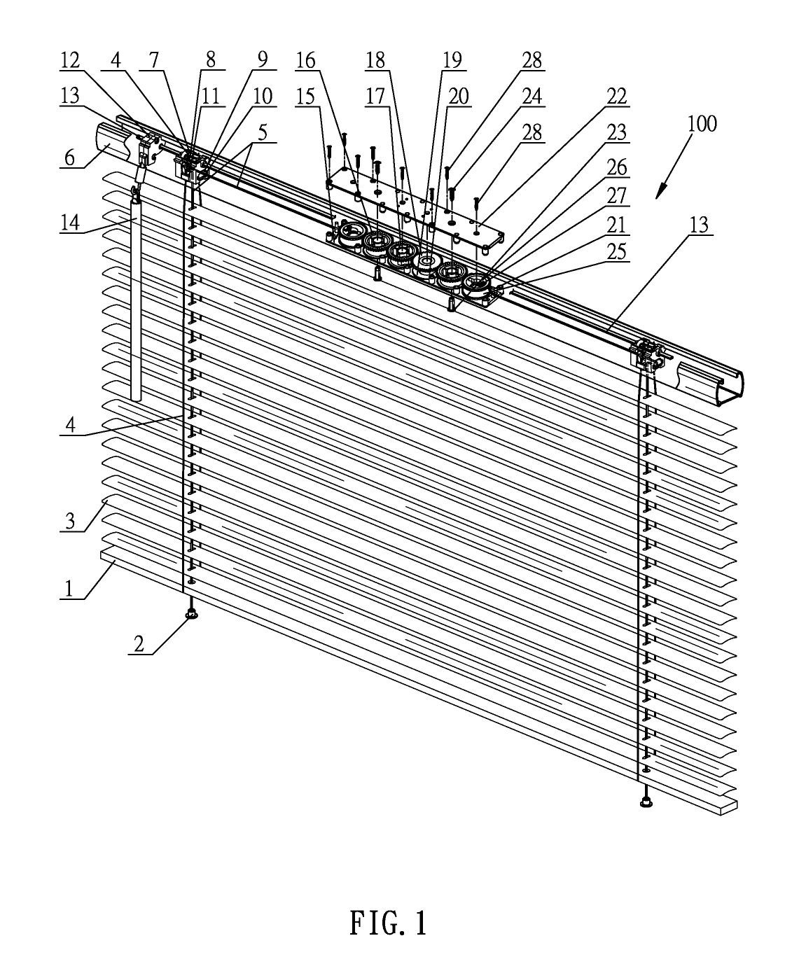

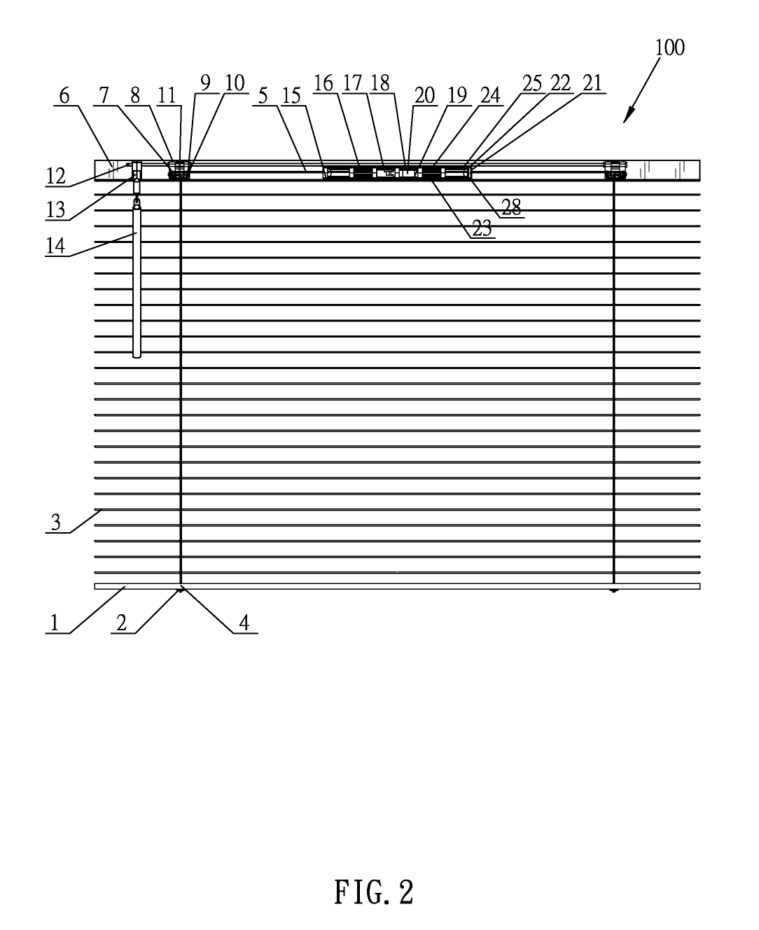

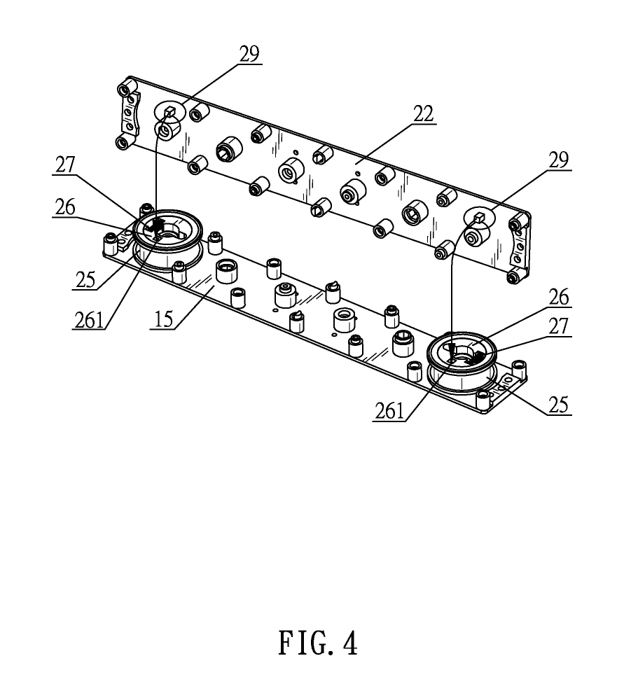

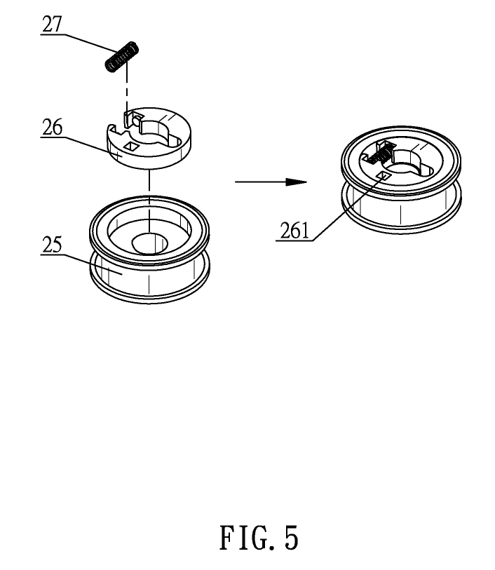

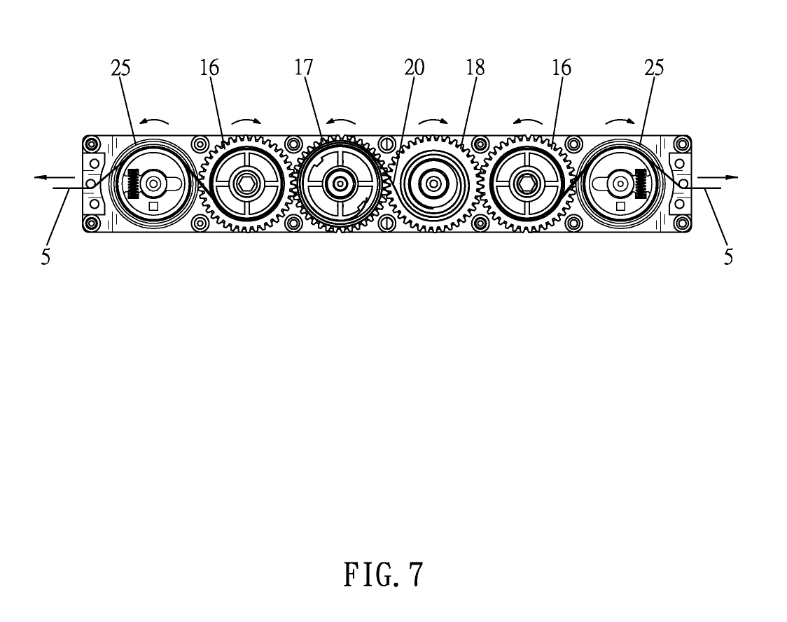

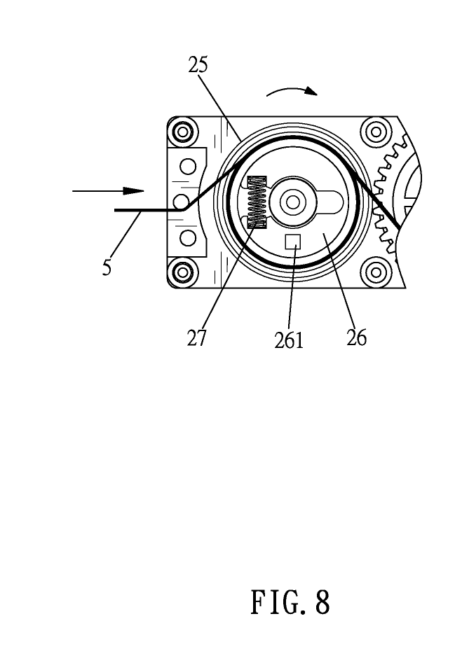

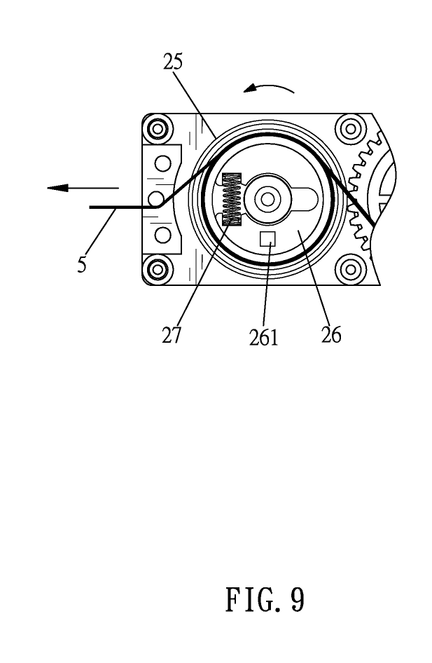

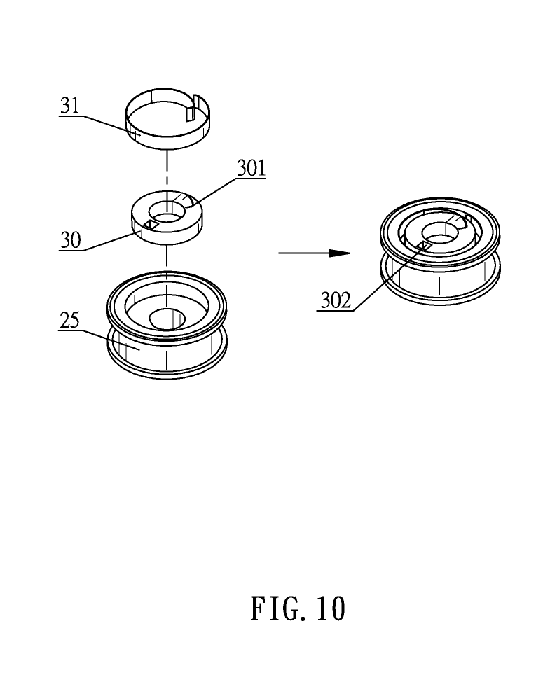

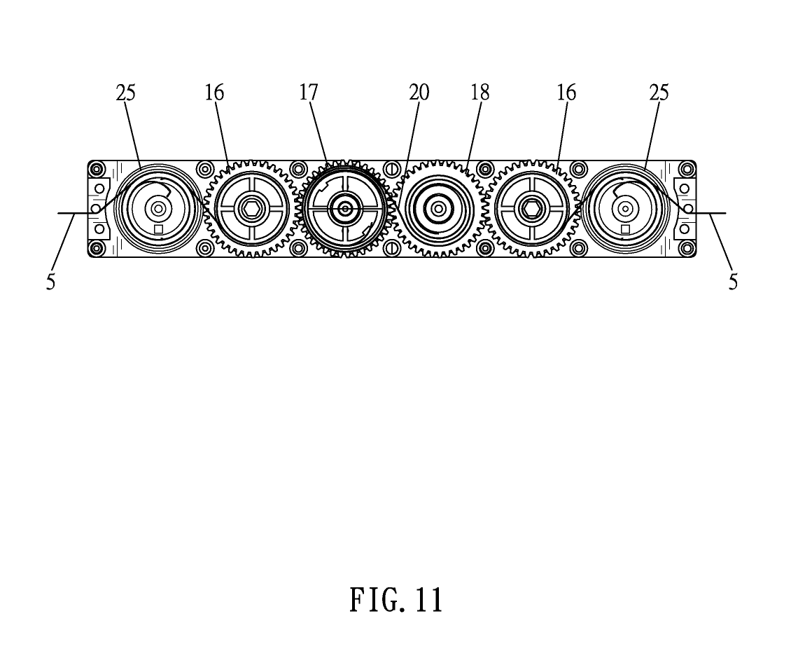

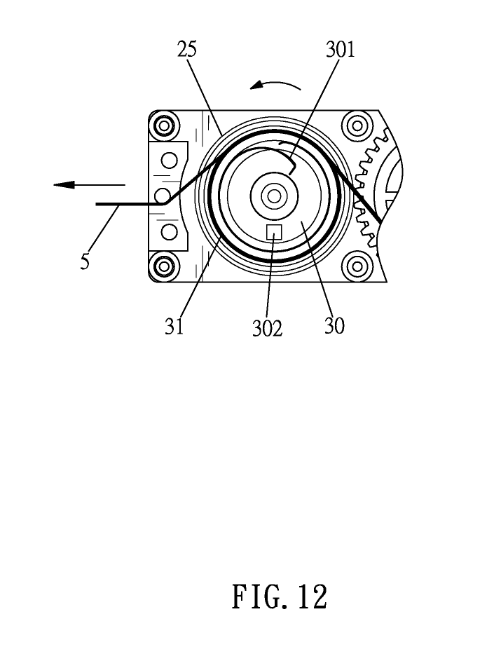

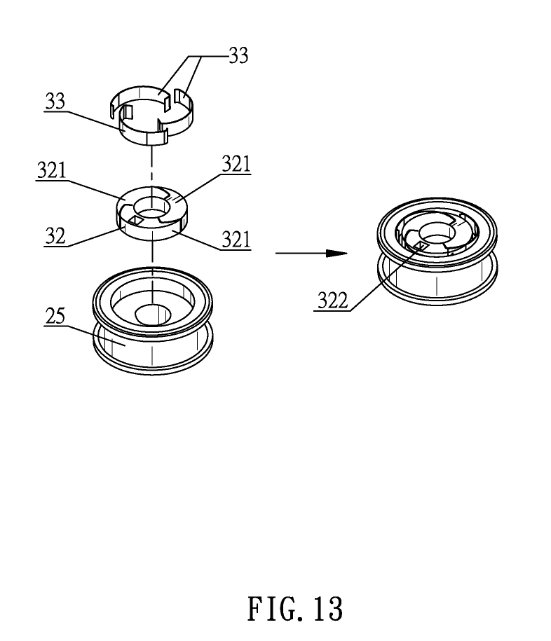

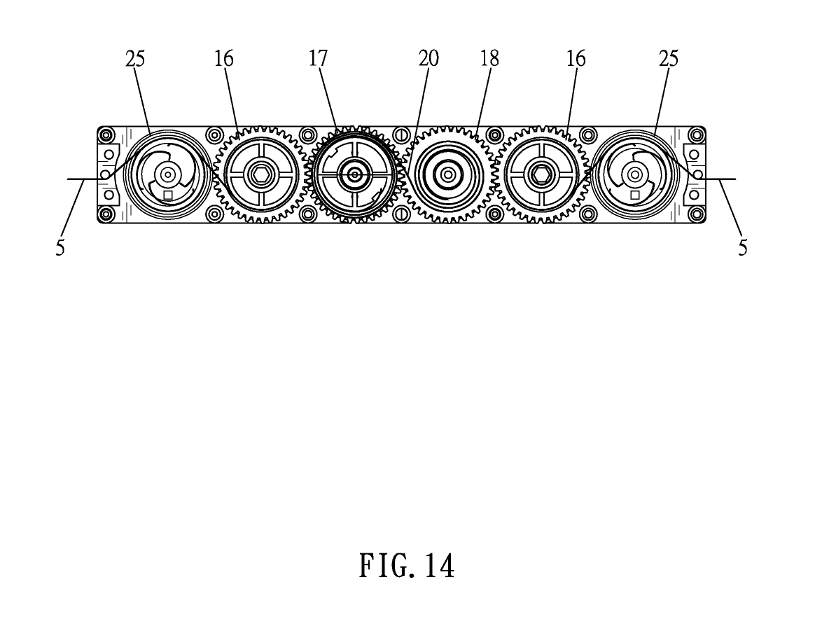

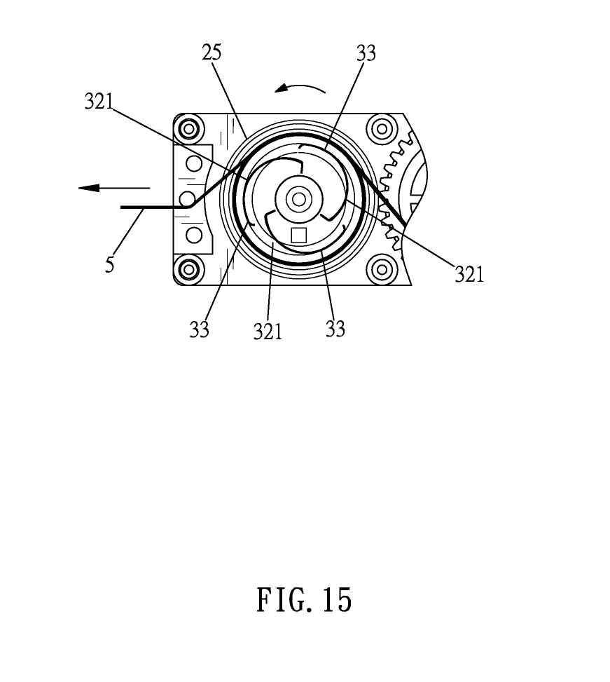

Please refer to FIGS. 1 to 15, the cordless window blind 100 comprises a headrail 6, a bottomrail 1, two sets of ladder cords 4, a plurality of slats 3, two pull cords 5, an ohm 12, a rotating bar 14, two pulley bases 7, two pulleys 6, two pulley resistance wheels 9, and two stoppers 2. The positioning structure 200 of the present invention is arranged in the headrail 6. The slats 3 are stacked one another. A shaft 13 is axially received in the headrail 6. Two sides of the shaft 13 are flat. The two pulley bases 7 cover the shaft 13 and arranged in the headrail 6. The two pulley bases 7 are respectively located adjacent to two ends of the positioning structure 200. Each pulley 8 covers the shaft 13 and arranged in the corresponding pulley base 7. A pull-cord guiding core 11 and a resistance core 10 are arranged in each pulley base 7. The resistance core 10 cooperates with the corresponding pulley 8. The two pull cords 6 are respectively connected with the two ends of the positioning structure 200. Each pull cord 5 is extended outwardly and toward the corresponding pulley base 7. Each pull cord 5 is passed through the pulley 8 of the corresponding pulley base 7 and the pull-cord guiding core 11 and then penetrated the headrail 6 and the slats 3 to the bottomrail 1 so as to be fastened by the corresponding stopper 2. Each set of ladder cords 4 is arranged corresponding to each pull cord 5. The ohm 12 covers the shaft 13. The rotating bar 14 is connected with the ohm 12 to control the shaft 13 to rotate. Furthermore, the two sets of the ladder cords 4 are controlled to rotate the slats 3. The above mentioned structure of the cordless window blind 100 is prior art except the positioning structure 200 of the present invention. The more detail structure is omitted.

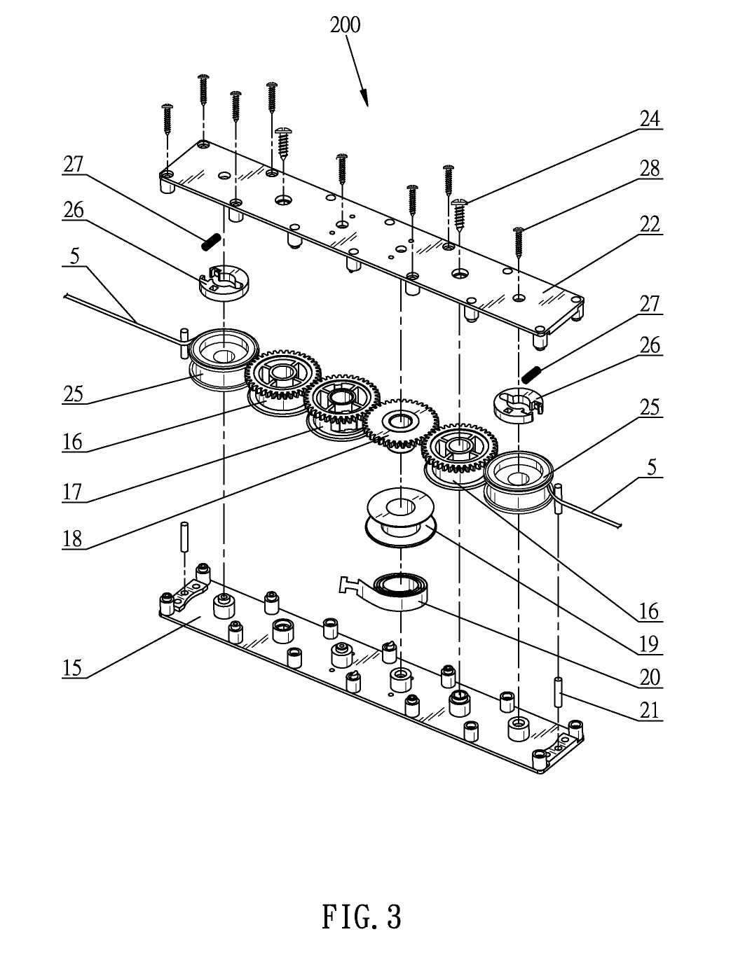

Please refer to FIGS. 3 to 9, a first embodiment of the positioning structure 200 for cordless window blind 100 comprises a lower case 15, a driving gear wheel 17, a driven gear wheel 18, a coil spring 20, two pull-cord gear wheels 16, two one-way resistance wheels 25, and an upper case 22.

The lower case 15 may be rectangular. The driving gear wheel 17 is pivotably arranged on the lower case 15.

The driven gear wheel 18 is pivotably arranged on the lower case 15 and engaged with the driving gear wheel 17.

The coil spring 20 winds around the driven gear wheel 18. Two ends of the coil spring 20 are respectively fastened at the driving gear wheel 17 and the driven gear wheel 18. In detail, the driven gear wheel 18 may be pivotably assembled to a shaft 19 and the coil spring 20 winds around the shaft 19.

Two pull-cord gear wheels 16 are pivotably arranged on the lower case 15 and respectively engaged with the driving gear wheel 17 and the driven wheel 18.

Two one-way resistance wheels 25 are pivotably arranged on the lower case 15. The two one-way resistance wheels 25 are respectively arranged adjacent to the two pull-cord gear wheels 16. Each one-way resistance wheel 25 is hollow and has a resistance block and an elastic member received therein. (That is, the resistance block and the elastic member are arranged in the one-way resistance wheel 25.) An outer diameter of the resistance block is roughly equal to an inner diameter of the one-way resistance wheel 25. In this embodiment, the resistance block is a C-shaped resistance block 26. The elastic member is a compression spring 27. The compression spring 27 is arranged at an open end of the C-shaped resistance block 26.

The C-shaped resistance block 26 has a polygonal hole 261 (such as square hole). One end of the compression spring 27 (elastic member) is fastened to the C-shaped resistance block 26. Two pull cords 5 are respectively fastened to the two pull-cord gear wheels 16. Each pull cord 5 is winded around an outer peripheral of corresponding one-way resistance wheel 25 at least one loop. In addition, a pull-cord centering core 21 is arranged at each end of the lower case 15 so as to align each pull cord 5 with the center of the headrail 6.

The upper case 22 is detachably covered the lower case 15. That is, the upper case 22 and the lower case 15 may be covered to each other by fixing pins 23 and fixed by screws 24. Furthermore, each pull-cord gear wheel 16, the driving gear wheel 17, the driven gear wheel 18, and each one-way resistance wheel 25 may be fixed by screws 28. Each pull-cord gear wheel 16, the driving gear wheel 17, the driven gear wheel 18, the coil spring 20, and each one-way resistance wheel 25 are arranged between the lower case 15 and the upper case 22. The upper case 22 has two polygonal posts 29 (such as square posts). Each polygonal post 29 is arranged corresponding to each polygonal hole 261 and each polygonal post 29 is inserted into the corresponding polygonal hole 261 to fix the resistance block 26 to prevent from rotating.

When manufacturing the positioning structure 200, the elasticity of the coil spring 20 should be selected large enough so that the cordless window blind 100 may be kept while the cordless window blind 200 is totally closed.

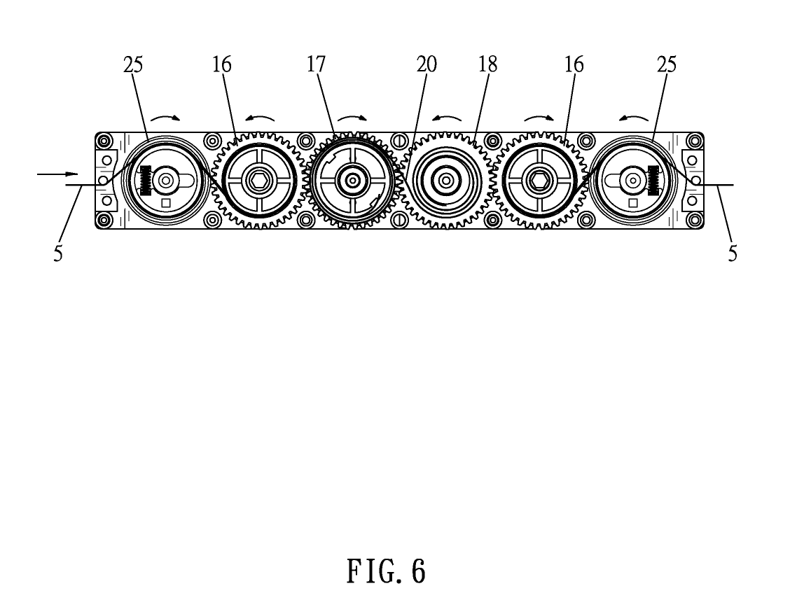

Please refer to FIGS. 6 to 15, in the process of opening the cordless window blind 100, that is, the process of pulling down the cordless window blind 100, the elastic member (compression spring 27) is “slightly” compressed so that attrition between the C-shaped resistance block 26 and the one-way resistance wheel 25 becomes smaller. (The “slightly” means that the deformation of the open end of the C-shaped resistance block 26 and being almost smaller or equal to the distance between the C-shaped resistance block 26 and the one-way resistance wheel 25.) Furthermore, the one-way resistance wheel 25 and the pull cord 5 which is not winded and crossed to the one-way resistance wheel 25 may be rotated synchronously so that the cordless window blind 100 may be easily opened by the user.

Since the weight of the slats 3 is shared by the ladder cords 4 gradually, the weight becomes smaller. When the cordless window blind 100 is totally opened, the downward force is only the weight of the bottomrail 1 but the coil spring 20 may be sprung back to result in closing the cordless window blind 100. At this time, the attrition is produced between the C-shaped resistance block 26 and the one-way resistance wheel 25. The attrition produces the resistance of rotation of the one-way resistance wheel 25. The one-way resistance wheel 25 may be not rotated so that the friction between the one-way resistance wheel 25 and the pull cords 5 becomes larger. Therefore, the pull cords 5 is stopped by the positioning structure 200 to prevent the cordless window blind 100 from unwanted closing.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A positioning structure for cordless window blind, comprising:
a lower case;
a driving gear wheel, pivotably arranged on the lower case;
a driven gear wheel, pivotably arranged on the lower case and engaged with the driving gear wheel;
a coil spring, winding around the driven gear wheel, and two ends of the coil spring are respectively fastened at the driving gear wheel and the driven gear wheel;
two pull-cord gear wheels, pivotably arranged on the lower case and respectively engaged with the driving gear wheel and the driven wheel;
two one-way resistance wheels, pivotably arranged on the lower case, the two one-way resistance wheels are respectively arranged adjacent to the two pull-cord gear wheels, each one-way resistance wheel has a resistance block and an elastic member received therein, the resistance block has a polygonal hole, one end of the elastic member is fastened to the resistance block, two pull cords are respectively fastened to the two pull-cord gear wheels, and each pull cord is winded around an outer peripheral of corresponding one-way resistance wheel at least one loop; and
an upper case, detachably covered the lower case, each pull-cord gear wheel, the driving gear wheel, the driven gear wheel, the coil spring, and each one-way resistance wheel are arranged between the lower case and the upper case, the upper case has two polygonal posts, each polygonal post is arranged corresponding to each polygonal hole, and each polygonal post is inserted into the corresponding polygonal hole.

2. The positioning structure for cordless window blind as claimed in claim 1, wherein the resistance block is a C-shaped resistance block, the elastic member is a compression spring, the compression spring is arranged at an open end of the C-shaped resistance block.

3. The positioning structure for cordless window blind as claimed in claim 1, wherein the resistance block is a ring-shaped resistance block, a break is formed at a peripheral of the ring-shaped resistance block, the elastic member is a ring-shaped shrapnel, one end of the ring-shaped shrapnel is inserted and fastened in the break of the ring-shaped resistance block and the other end thereof is extended counterclockwise and contacted with an inner peripheral of the one-way resistance wheel.

4. The positioning structure for cordless window blind as claimed in claim 1, wherein the resistance block is a ring-shaped resistance block, three breaks are angularly spaced apart from one another and formed at a peripheral of the ring-shaped resistance block, the elastic member is composed of three ring-shaped shrapnels, one end of each ring-shaped shrapnel is inserted and fastened in each break of the ring-shaped resistance block and the other end thereof is extended counterclockwise and contacted with an inner peripheral of the one-way resistance wheel.

5. The positioning structure for cordless window blind as claimed in claim 1, wherein the driven gear wheel is pivotably assembled to a shaft, and the coil spring winds around the shaft.
